(19) United States
(12) Patent Application Publication
(10) Pub. No.: US 2026/0023609 A1
(43) Pub. Date: Jan. 22, 2026

(54) METHODS AND SYSTEMS FOR AUTOMATED SCHEDULER-CONTROLLED NODE TESTING IN A COMPUTING CLUSTER

(71) Applicant: Penguin Computing, Inc., Fremont, CA (US)

(72) Inventors: Nicholas Mccollum, Decatur, AL (US); Kevin Manalo, Saint Johns, FL (US)

(73) Assignee: Penguin Computing, Inc., Fremont, CA (US)

(21) Appl. No.: 18/778,312

(22) Filed: Jul. 19, 2024

(51) Int. Cl. G06F 9/50; G06F 9/48

(52) U.S. Cl. CPC G06F 9/5027; G06F 9/4881

(57) ABSTRACT

A system and method for implementing a task scheduler-controlled health tests of computing nodes includes detecting a plurality of idle nodes of a cluster of computing nodes, selecting a set of computing nodes for a node health assessment; assigning the set of computing nodes to a node health assessment queue, wherein when the assignment of the set of computing nodes to the node health assessment queues renders the set of computing nodes unavailable for executing one or more computing tasks; submitting a set of instructions for executing the node health assessment; obtaining assessment results based on the execution of the node health assessment by the set of computing nodes; determining a state of health data for the set of computing nodes based on the assessment results; and reallocating the set of computing nodes from the node health assessment queue based on the state of health data.

### TECHNICAL FIELD

This invention relates generally to the computer cluster management field, and more specifically to new and useful systems and methods for conducting health checks of and detecting unhealthy computing nodes and components of computing nodes in the computer cluster management field.

### BACKGROUND

Traditional methods for ensuring the integrity and performance of a cluster of computers often rely heavily on self-reporting mechanisms from the hardware components or computers within the cluster. These methods await error signals such as logs, messages, or other indications from the hardware to identify issues. However, this approach is insufficient as it fails to detect problems that do not self-report, leading to undiagnosed issues that degrade cluster performance.

Some systems may employ single-point health checks provided by server hardware vendors, which monitor the status of a single computing node and its components. These systems are limited as they depend on the hardware's ability to recognize and communicate its own failures. Such reliance on self-reporting not only overlooks silent failures but also neglects the health of the network interconnected components. Given that modern GPU servers and similar servers are increasingly connected via high-speed fiber-optic networks, direct attach copper, and/or the like, this oversight can result in unacknowledged bottlenecks and faults within the cluster's communication infrastructure.

The technology introduced herein addresses the aforementioned limitations by providing a robust health check framework that actively tests nodes bi-directionally against their peers within the cluster. At least this innovative approach ensures the reliable detection of faulty computing nodes within a cluster without depending on vendor-specific, single-server health checks. By facilitating indirect testing of the network interconnects, the invention comprehensively evaluates the health of the entire cluster of computers, including various network components of the cluster of computers. Consequently, the inventions described herein offer improved systems and methods for maintaining optimal cluster performance and reliability.

### SUMMARY OF THE INVENTION(S)

In one or more embodiments, a method for automated scheduler-controlled computing node testing in a computing cluster includes detecting, by a computing task scheduler, a plurality of idle nodes of a cluster of computing nodes, wherein the plurality of idle nodes includes computing nodes of the cluster of computing nodes that are in an idle state; selecting, by the computing task scheduler, a set of computing nodes of the plurality of idle nodes for a node health assessment; assigning the set of computing nodes to a node health assessment queue, wherein when the assignment of the set of computing nodes to the node health assessment queues renders the set of computing nodes unavailable for executing one or more computing tasks assigned by the computing task scheduler to the cluster of computing nodes; submitting, by the computing task scheduler, to the set of computing nodes within the node health assessment queue a set of instructions for executing the node health assessment; obtaining, by the computing task scheduler, assessment results based on the execution of the node health assessment by the set of computing nodes; determining a state of health data for each computing node of the set of computing nodes based on the assessment results; and reallocating, by the computing task scheduler, the set of computing nodes from the node health assessment queue based on the state of health data for each computing node of the set of computing nodes.

In one or more embodiments, determining the state of health data includes identifying one or more computing nodes of the set of computing nodes as having a healthy state, wherein the healthy state relates to a likely operational status of a subject computing node satisfying the node health assessment.

In one or more embodiments, reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the computing task scheduler to the cluster of computing nodes.

In one or more embodiments, the one or more computing nodes of the set of computing nodes having the healthy state are restricted from executing another instance of the node health assessment for a predetermined period.

In one or more embodiments, determining the state of health data includes identifying one or more computing nodes of the set of computing nodes as having an unhealthy state, wherein the unhealthy state relates to a likely operational status of a subject computing node that does not satisfy the node health assessment.

In one or more embodiments, reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the computing task scheduler to the cluster of computing nodes.

In one or more embodiments, the execution of the node health assessment by the set of computing nodes includes: executing bi-directional testing between distinct pairs of computing nodes of the set of computing nodes by executing one or more operational health tests of the node health assessment.

In one or more embodiments, selecting, by the computing task scheduler, the set of computing nodes of the plurality of idle nodes includes bypassing one or more computing nodes of the plurality of idle nodes that do not satisfy idleness criteria, and the idleness criteria requiring a given idle computing node to be (1) in an idle operational state and (2) without computing tasks scheduled for an impending period.

In one or more embodiments, the method further includes configuring the computing task scheduler with one or more node health assessment criteria including non-interference automated node testing instructions, wherein the non-interference automated node testing instructions, when executed by the computing task scheduler, prioritizes for the node health assessment computing nodes of the plurality of idle nodes without a scheduled computing task while bypassing computing nodes of the plurality of idle nodes with scheduled computing tasks.

In one or more embodiments, a computer-program product embodied in a non-transitory machine-readable storage medium storing computer instructions that, when executed by one or more processors, perform operations including detecting, by a computing task scheduler, a plurality of idle nodes of a cluster of computing nodes, wherein the plurality of idle nodes includes computing nodes of the cluster of computing nodes that are in an idle state; selecting, by the computing task scheduler, a set of computing nodes of the plurality of idle nodes for a node health assessment; assigning the set of computing nodes to a node health assessment queue, wherein when the assignment of the set of computing nodes to the node health assessment queues renders the set of computing nodes unavailable for executing one or more computing tasks assigned by the computing task scheduler to the cluster of computing nodes; submitting, by the computing task scheduler, to the set of computing nodes within the node health assessment queue a set of instructions for executing the node health assessment; obtaining, by the computing task scheduler, assessment results based on the execution of the node health assessment by the set of computing nodes; determining a state of health data for each computing node of the set of computing nodes based on the assessment results; and reallocating, by the computing task scheduler, the set of computing nodes from the node health assessment queue based on the state of health data for each computing node of the set of computing nodes.

In one or more embodiments, determining the state of health data includes identifying one or more computing nodes of the set of computing nodes as having a healthy state, wherein the healthy state relates to a likely operational status of a subject computing node satisfying the node health assessment.

In one or more embodiments, reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the computing task scheduler to the cluster of computing nodes.

In one or more embodiments, the one or more computing nodes of the set of computing nodes having the healthy state are restricted from executing another instance of the node health assessment for a predetermined period.

In one or more embodiments, determining the state of health data includes identifying one or more computing nodes of the set of computing nodes as having an unhealthy state, wherein the unhealthy state relates to a likely operational status of a subject computing node that does not satisfy the node health assessment.

In one or more embodiments, reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the computing task scheduler to the cluster of computing nodes.

In one or more embodiments, the execution of the node health assessment by the set of computing nodes includes: executing bi-directional testing between distinct pairs of computing nodes of the set of computing nodes by executing one or more operational health tests of the node health assessment.

In one or more embodiments, selecting, by the computing task scheduler, the set of computing nodes of the plurality of idle nodes includes bypassing one or more computing nodes of the plurality of idle nodes that do not satisfy idleness criteria, and the idleness criteria requiring a given idle computing node to be (1) in an idle operational state and (2) without computing tasks scheduled for an impending period.

In one or more embodiments, a computer-implemented method includes detecting, by a task scheduler, a plurality of idle nodes of a cluster of computing nodes, wherein the plurality of idle nodes includes computing nodes of the cluster of computing nodes that are in an idle state; selecting, by the task scheduler, a set of computing nodes of the plurality of idle nodes for a node health assessment; assigning the set of computing nodes to a node health assessment queue, wherein when the assignment of the set of computing nodes to the node health assessment queues renders the set of computing nodes unavailable for executing one or more computing tasks assigned by the task scheduler to the cluster of computing nodes; submitting, by the task scheduler, to the set of computing nodes within the node health assessment queue a set of instructions for executing the node health assessment; obtaining, by the task scheduler, assessment results based on the execution of the node health assessment by the set of computing nodes; determining a state of health data for each computing node of the set of computing nodes based on the assessment results; and reallocating, by the task scheduler, the set of computing nodes from the node health assessment queue based on the state of health data for each computing node of the set of computing nodes.

In one or more embodiments, determining the state of health data includes identifying one or more computing nodes of the set of computing nodes as having a healthy state, wherein the healthy state relates to a likely operational status of a subject computing node satisfying the node health assessment; and reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the task scheduler to the cluster of computing nodes.

In one or more embodiments, the one or more computing nodes of the set of computing nodes having the healthy state are restricted from executing another instance of the node health assessment for a predetermined period; and reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the task scheduler to the cluster of computing nodes.

### BRIEF DESCRIPTION OF THE FIGURES

FIG. 1 illustrates a schematic representation of a system in accordance with one or more embodiments of the present application;

FIG. 1A illustrates a schematic representation of a subsystem of the system in accordance with one or more embodiments of the present application;

FIG. 2 illustrates an example method in accordance with one or more embodiments of the present application;

FIG. 3 illustrates an example schematic for identifying idle computing nodes of a cluster of computing nodes in accordance with one or more embodiments of the present application;

FIG. 4 illustrates an example schematic for selecting a subset of idle computing nodes for a node health assessment in accordance with one or more embodiments of the present application;

FIG. 5 illustrates an example schematic for routing or assigning a set of idle computing nodes to an assessment queue in accordance with one or more embodiments of the present application;

FIG. 6 illustrates an example schematic for obtaining assessment data from an assessment queue in accordance with one or more embodiments of the present application; and

FIG. 7 illustrates an example schematic for reallocating computing nodes based on health state data to a remediation queue or to available computing resources in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Enhanced Cluster Health Management and Unhealthy Node Detection

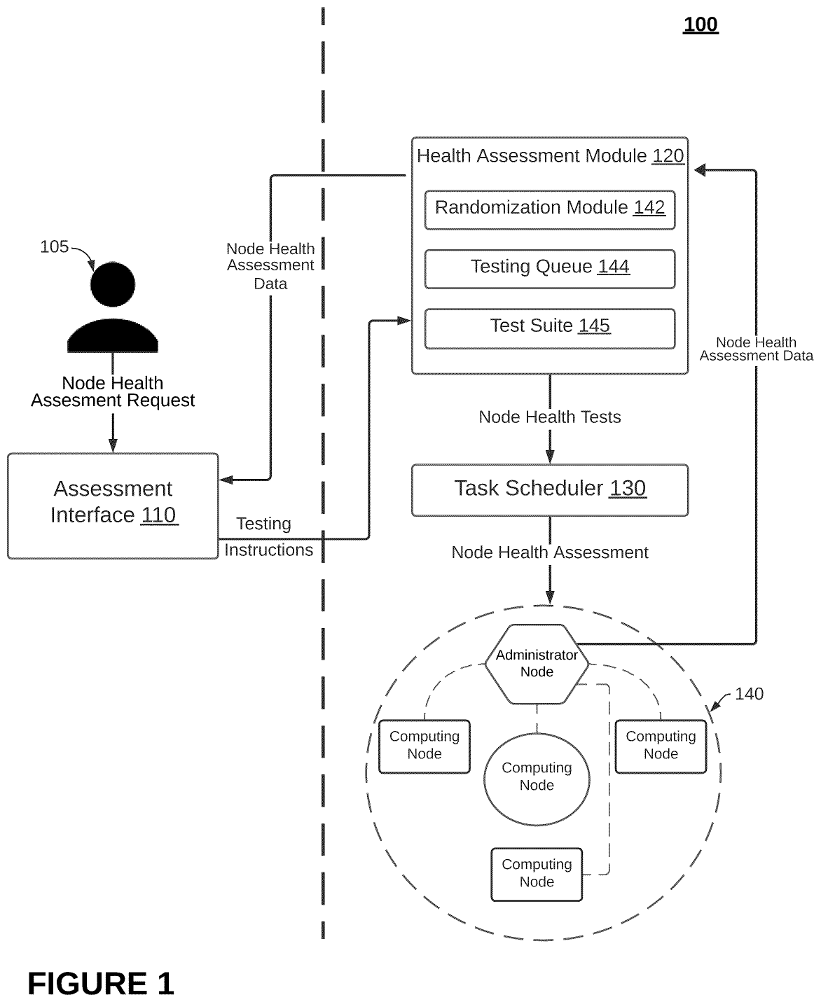

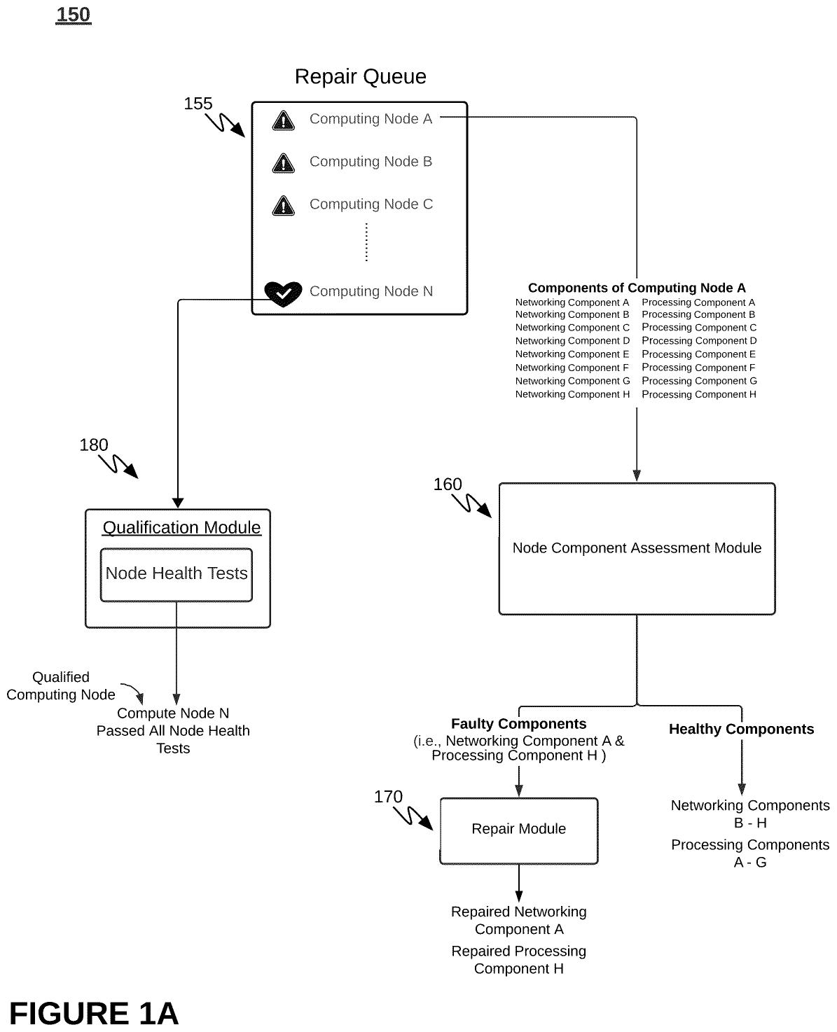

As shown in FIG. 1, a system 100 implementing enhanced cluster health management and for detecting unhealthy computing nodes within a cluster of computer nodes includes a node health assessment interface 110, a health assessment module 120, and a task scheduler 130 for assessing the health of a cluster of computing nodes 140.

### 1.1 Computing Node Health Assessment Interface

The node health assessment interface 110, which may also be referred to herein as assessment interface 110, preferably includes a command interface or system programming interface or console through which an administrator 105 may operate to execute a node health assessment of a target cluster of computing nodes 140. In a preferred embodiment, the assessment interface 110 is preferably implemented by one or more computers and may be in operable control communication with one or more computing nodes of a target cluster of computing systems. In such preferred embodiment, the assessment interface 110 may function to receive, as input, one or more user commands for executing one or more aspects of a node health assessment of a target cluster of computing nodes 140 and output control signals to the one or more computing nodes of the target cluster of computing nodes 140.

In one or more embodiments, the one or more computing nodes of a target cluster of computing nodes 140 that may be operably controlled via the assessment interface 110 preferably include an administrator node. In such embodiments, the administrator node comprises one computing node of the target cluster of computing nodes 140 that may be in network communication with all computing nodes of the target cluster of computing nodes 140. The administrator node executing commands or instructions from the assessment interface 110 may function to administer any suitable tests to the target cluster of computing nodes 140 including, but not limited to, a node health assessment. In some embodiments, the administrator node may be referred to herein as a head node or a control node depending on its operation within the cluster of computing nodes 140. Accordingly, the administrator node 105 may have installed cluster management software or similar applications that preferably enables the administrator node 105 to coordinate activities of the cluster of computing nodes 140, manage resource allocation, perform scheduling (e.g., integrated scheduler 130), and/or support maintaining an overall health of the cluster of computing nodes 140.

Additionally, or alternatively, the administrative node may be in operable control communication of a parallel file system or the like for administering any suitable tests, including a node health assessment, to a target cluster of computing nodes 140. Additionally, or alternatively, the administrative node may include an assessment agent installed thereon that may be in communication and operably controlled via commands from the assessment interface 110. In some embodiments, the assessment agent of the administrator node based on command inputs from the assessment interface 110 may function to automatically execute one or more operations or functions of a node health assessment against a target cluster of computing nodes 140.

### 1.2 Health Assessment Module

The health assessment module 120, in one or more embodiments, which is in operable communication with one or more of the assessment interface 110, the node assessment scheduler 130, and cluster of computing nodes 140 may operate to configure one or more node health assessments and/or execute one or more node health assessments against a target set of computing nodes of the cluster of computing nodes 140. In one or more embodiments, the health assessment module 120 may function to store and/or have access to a test suite 145, which is sometimes referred to herein as a pool of node health tests, that includes a plurality of node health tests. At runtime, the health assessment module 120 may function to source from the test suite 145 one or more node health tests, which may be executed either serially or in parallel against computing nodes of the cluster of computing nodes 140.

In one or more embodiments, the health assessment module 120 may be implemented in cooperation with a network file system, a parallel file system or the like. In such embodiments, the health assessment module 120 may be implemented by an administrative computing node of a target cluster of computing nodes, the administrative computing node may be sometimes referred to herein as a “head node” or “node zero”. Additionally, or alternatively, each computing node in the target cluster of computing nodes may store a copy of the tests and/or assessments associated with an operation of the health assessment module 120. In this way, commands and/or signals from the health assessment module 120 may cause any or each of the computing nodes of the target cluster to access one or more tests and/or assessments and execute the tests or assessments concurrently. In such embodiments, the outputs of the execution of the tests and/or assessments by the target cluster of computing nodes may be stored to or served out to the network file system.

Additionally, or alternatively, the health assessment module 120 may function to implement and/or include one or more of a randomization module 142 and a testing queue 144 that may operate together for initializing and executing a node health assessment of computing nodes of a cluster of computing nodes 140. In one or more embodiments, the randomization module 142 may function to ensure that different first computing nodes are seeded to prevent biased results on the basis of an initial computing node selection from a batch of computing nodes subject to a node health assessment.

### 1.3 Automated Task Scheduler

The task scheduler 130 preferably functions as an orchestration layer that automatically facilitates a node health assessment. In a preferred embodiment, the task scheduler 130 may function to integrate node health assessments directly into an operational workflow of the cluster of computing nodes 140. Accordingly, the task scheduler 130 may be multi-faceted in its automated application of node health assessments on a predetermined schedule or dynamically during a pre-job deployment of a batch of computing nodes. It shall be recognized that the task scheduler 130 may sometimes be referred to herein as an “automated task scheduler” or a “computing task scheduler”.

In one or more embodiments, the task scheduler 130 may function to continually and/or periodically monitor a state of computing nodes within the cluster of computing nodes 140 to identify idle computing nodes that are not currently allocated to user jobs. In such embodiments, the task scheduler 130 may batch the idle computing nodes to the node testing queue 144 for a node health assessment.

Additionally, or alternatively, in one or more embodiments, the task scheduler 130 may function programmed or configured to automatically execute node health tests. In such embodiments, the task scheduler 130 may be programmed or configured with node health testing parameters thereby enabling the task scheduler 130 to identify candidate computing nodes that may be eligible for a node health assessment.

As a non-limiting example, the health testing parameters may include one or more node health assessment criteria including non-interference automated node testing instructions. In such example, the non-interference automated node testing instructions, when executed by the task scheduler 130, prioritizes for the node health assessment computing nodes of the plurality of idle nodes without a scheduled computing task while bypassing computing nodes of the plurality of idle nodes with scheduled computing tasks.

It shall be recognized that the task scheduler 130 may be configured and/or encoded with any suitable set of instructions that enable the task scheduler 130 to perform the processes, steps, and/or methods described herein including, but not limited to, those described in method 200 and the methods of the incorporated patent applications.

### 1.4 Cluster of Computing Nodes

The cluster of computing nodes 140 preferably includes a plurality of distinct computing nodes where each distinct node comprises a computer. In a preferred embodiment, the computer typically includes a server-grade machine, equipped with one or more of central processing units (CPUs), graphical processing units (GPUs), both, or similar processing components capable of executing tasks and running applications. In one or more embodiments, the plurality of distinct computing nodes in a cluster may include network interconnects comprising high-speed communication pathways that link the computing nodes together, facilitating rapid data transfer. One or more examples of network interconnects may include, but should not be limited to, InfiniBand, Ethernet, fiber-optic connections that may enable the computing nodes to operate in concert for distributed computing tasks.

Additionally, or alternatively, a cluster of computing nodes may include a storage system having an associated memory or data storage solutions that may range from local disk drives within each computing node of the cluster of computing nodes 140 to shared storage systems, such as storage area network (SAN) or network attached storage (NAS), accessible by all computing nodes in cluster 140 for distributed file systems and data persistence. In a preferred embodiment, the cluster of computing nodes 140 preferably employs a parallel file system that allows multiple computing nodes to access and process data simultaneously, which may increase throughput and efficiencies of the computing nodes.

### 1.5 Subsystem for Faulty Component Detection

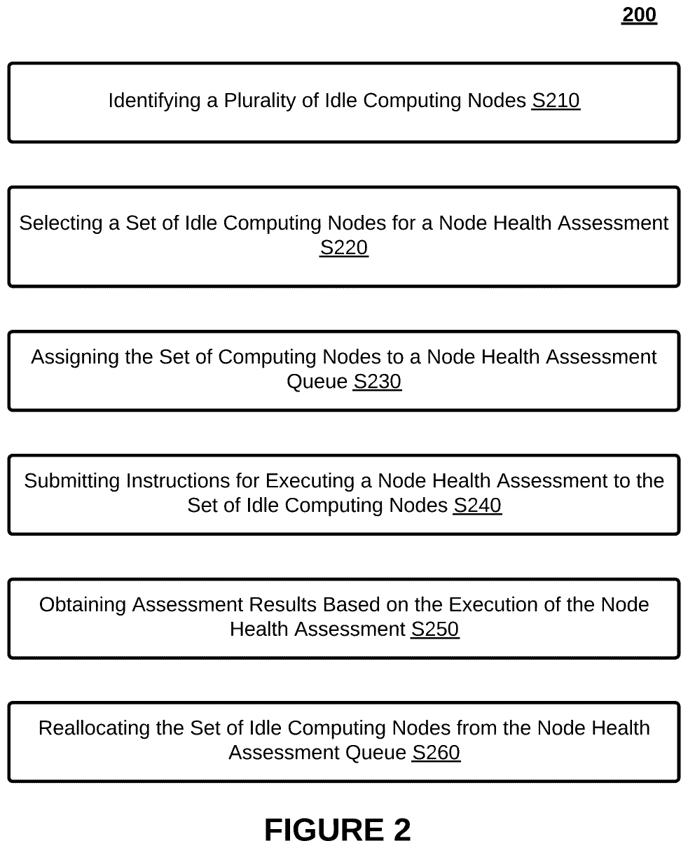

In one or more embodiments, system 100 includes the subsystem 150 for enhanced identification and/or detection of faulty components of a suspected unhealthy computing node, as shown by way of example in FIG. 2. Subsystem 150 preferably functions to evaluate a component health of a target computing node that may have been classified as being unhealthy. That is, in one or more embodiments, subsystem 150 in operation may function to identify and/or characterize one or more faulty components of a target computing node by executing a component node health assessment for one or more hardware and/or software components of the target computing node.

In some embodiments, the subsystem 150 may include or may be in operable communication with a repair queue 155, a node component assessment module 160, a repair module 170, and a qualification module 180. The repair queue 155 preferably includes a data structure or the like storing a listing or mapping of one or more computing nodes having a classification of an unhealthy state. In other words, the repair queue 155 preferably functions to itemize computing nodes that may need repair resulting from non-performant components or similar hardware or software failures. The repair queue 155, in such embodiments, may include a listing of unhealthy computing nodes together with associated node health assessment data observed or collected from one or more upstream health assessments (e.g., node health assessment module 120 or the like).

The node component assessment module 160, which is sometimes referred herein as the “node component health assessment module” preferably functions to assess a relative health of the components of a target computing node. In some embodiments, the node component assessment module 160 sources or identifies a target computing node for an assessment from repair queue 155, however, it shall be recognized that node component assessment module 160 may identify or receive a target computing node for an assessment from any source. In one or more embodiments, the node component assessment module 160 may function to prepare the components of a target computing node for testing by generating a plurality of unique combination of node component pairs based on an input of a listing or the like of the components of the target computing node and a listing or the like of the components of a healthy (i.e., golden model) target computing node. In a preferred embodiment, node component health assessment module 160 may function to compute a Cartesian product between the set of components of the target computing node (e.g., unhealthy computing node) and the set of components of the healthy computing node. As a result, node component health assessment module 160 may function to generate or output a listing or a mapping of all possible unique pairings between the components of the target computing node and the healthy computing node for peer-to-peer testing and/or the like.

Additionally, or alternatively, node component assessment module 160 may have access to a node component test suite that includes a plurality of tests for evaluating various components of a computing node. In some embodiments, node component assessment module 160 may implement a test selection matrix (not shown) that includes a mapping between distinct components mapped to or associated with one or more available tests for evaluating the associated components.

In use, node component assessment module 160 preferably performs an assessment of the components of a target computing node and may function to output one or more signals or classifications indicating whether a component of the target computing node is healthy or faulty. In the circumstances in which a component is classified by node component assessment module 160 as faulty, node component assessment module 160 may route data associated with the component classified as being faulty (i.e., the faulty node component) to repair module 170 for remediating the one or more faults or defects of the target computing node.

In one or more embodiments, once a computing node has been repaired via one or more operations associated with the repair module 170, the qualification module 180 may be implemented for ensuring that the repaired computing node is healthy and readied to return to service. In such embodiments, the qualification module 180 may function to execute a standard suite of health tests against the repaired computing node that may confirm or validate that the repairs to the repaired computing node are successful. In a variation, the qualification module 180 may function to execute a select set of health tests based on the one or more node components that were repaired. In such variation, the qualification module 180 may function to select one or more tests that map to a fault type or previously faulty node components for qualifying the repaired computing node. In response to a successful qualification (e.g., satisfaction of the one or more node health tests), the qualification module 180 may function to flag and/or identify the repaired computing node as being ready for service. Conversely, if the qualification is unsuccessful, the qualification module 180 may function to route the repaired computing node upstream to one or more of the health assessment module 120, the subsystem 150, and/or any other module or component of the system 100 for identifying a health state of the repaired computing node and/or fault characterization of one or more components of the repaired computing node.

### 2. Method of Implementing a Scheduler for Automated Node Health Assessments

As shown in FIG. 2, a method 200 for implementing a scheduler-controller automated node health assessments of computing nodes includes identifying a plurality of idle computing nodes S210, selecting a set of idle computing nodes for a node health assessment S220, assigning the set of computing nodes to a node health assessment queue S230, submitting a set of instructions for executing the node health assessment to the set of idle computing nodes within the node health assessment queue S240, obtaining assessment results based on the execution of the node health assessment by the set of idle computing nodes S250, and reallocating the set of idle computing nodes from the node health assessment queue based on the respective state of health of the computing nodes S260.

The method 200 as implemented by one or more systems (e.g., system 100) preferably provides a scalable solution for monitoring and maintaining the health of computing clusters by using a job scheduler to automatically perform node health assessments of clusters of computing nodes. In particular, the method 200 in various embodiments functions to programmatically integrate node health assessment capabilities into a job scheduler for a cluster of computing nodes. The resulting scheduler may function to systematically, intelligently, and without human intervention perform node health assessments of computing nodes within the cluster of computing based on determining a state of each computing node within the cluster thereby identifying underperforming computing nodes and/or components and preventing performance degradation of the cluster of computing nodes.

### 2.10 Detection of Idle Computing Nodes

S210, which includes identifying a plurality of idle computing nodes, may function to detect by an automated task scheduler a plurality of computing nodes of a cluster of computing nodes that may be in an idle state. In a preferred embodiment, the automated task scheduler may be in direct or indirect signal communication with each of a plurality of computing nodes of a cluster of computing nodes. Based on the communication connection between the automated task scheduler and the cluster of computing nodes, the automated task scheduler may function to monitor a state of each computing node within the cluster of computing nodes. Accordingly, in one or more embodiments, the automated task scheduler may function to continuously or periodically assess an operational status of each computing node within the cluster of computing nodes to determine the respective computing node's availability for executing a node health of assessment.

Additionally, or alternatively, an idle computing node as referred to herein preferably relates to a computing node that may not be currently engaged in executing any computing tasks, networking tasks, or jobs and is further in a state in which the computing node may be reassigned for other purposes including, but not limited to, executing one or more node health assessments. Accordingly, in one or more embodiments, the plurality of idle computing nodes identified by the automated task scheduler preferably includes all computing nodes that may be in this idle state, as an operational status, and are therefore available for assessing a relative health of the computing nodes via one or more node health assessments or tests.

Accordingly, the automated task scheduler may function to monitor a status of each computing node in the cluster of computing nodes and in such embodiments, monitoring the computing nodes may include monitoring various operational attributes of each computing node within the cluster. In one or more embodiments, one or more operational attributes of each computing node may include processing utilization (e.g., GPU usage, CPU usage, and the like), memory utilization, networking activity, and/or current and/or impending job assignments. In some embodiments, the automated task scheduler may function to actively monitor each of the computing nodes by sending one or more status request signals or passively monitor each of the computing nodes by periodically receiving status signals from each of the computing nodes, which may be self-initiated by the computing nodes.

In response to receiving or obtaining status data from the computing nodes of the cluster of computing nodes, S210 may function to cause the automated task scheduler to compute or determine a state of each respective computing node associated with the status data. In one or more embodiments, determining whether a computing node is in an idle state or in an active state may include evaluating the status data against idle criteria utility thresholds (e.g., idle thresholds, active thresholds, and/or the like). In such embodiments, based on the evaluation of the status data against idle criteria, S210 may function to determine a status for each computing node and associate an idle status or not idle status with each respective computing node. It shall be recognized that while, in some embodiments, a given computing node may not be considered to be in an active state or not idle state, S210 may function to determine that the given computing may not be given an idle status based on a temporal proximity of an impending or scheduled job for the given computing node. That is, in such embodiments, the given computing node may be physically idle based on the idle criteria but assigned a not idle status because of one or more jobs or tasks scheduled to be executed by the given computing node within a given upcoming period.

Additionally, or alternatively, the automated task scheduler, for each computing node that satisfies idle criteria (i.e., an idle node), may function to itemize the computing node to a list of idle computing nodes. In one or more embodiments, S210 may function to dynamically update the list of idle computing nodes to include or remove given computing nodes as the status of the computing nodes changes thereby ensuring that only currently idle computing nodes are included within the list of idle computing nodes.

At least one technical benefit of detecting or identifying idle computing nodes includes ensuring that subsequent node health assessments do not interfere with ongoing or impending computing tasks, networking tasks or other jobs performed by computing nodes within a target cluster thereby maintaining an overall efficiency and performance of the target cluster of computing nodes. That is, an accurate identification of idle computing nodes may ensure that only those computing nodes that are genuinely available and not currently needed for active or impending jobs are selected for health assessment thereby optimizing the assessment and use of cluster resources.

### 2.20 Selecting a Batch of Idle Computing Nodes

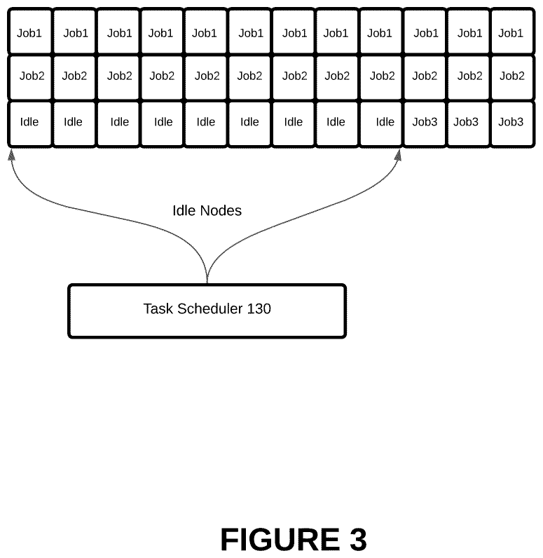

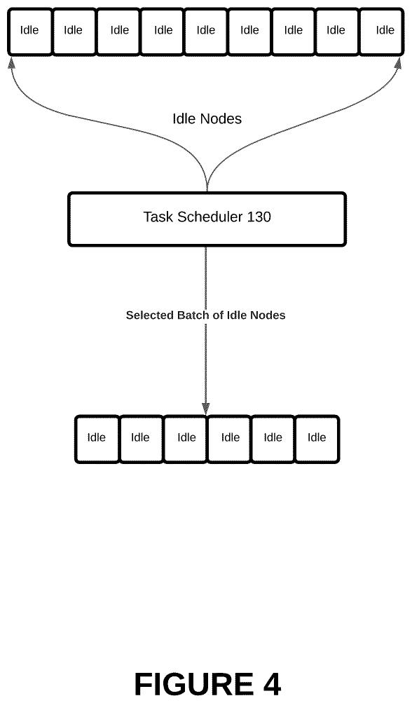

S220, which includes selecting a set of idle computing nodes for a node health assessment, may include causing the automated task scheduler to identify and choose specific computing nodes from the plurality of idle computing nodes detected in S210, as shown by way of example in FIG. 3. In a preferred embodiment, the automated task scheduler applies a selection algorithm to determine the optimal set of idle computing nodes for the health assessment, ensuring that the selection is based on criteria that optimize the efficiency and effectiveness of the assessment process, as shown by way of example in FIG. 4.

In one or more embodiments, the selection of the set or batch of idle computing nodes for a node health assessment may be based on evaluating the plurality of idle computing nodes against selection factors or criteria used by the automated task scheduler. In such embodiments, the selection factors may include, but should not be limited to, a node type of an eligible idle computing node, node testing history, node testing policy (e.g., subscriber-defined testing parameters), historical performance data, physical location, workload distribution, and/or the like of each of the plurality of idle computing nodes.

Accordingly, in one or more embodiments, the automated task scheduler may function to apply the selection algorithm to the list of idle nodes identified in S210. In such embodiments, the selection algorithm may use random sampling, round-robin selection, or weighted criteria to ensure a balanced selection of idle computing nodes for a comprehensive health assessment. The automated task scheduler may function to assess each of the plurality of idle computing nodes against the selection criteria of the selection algorithm. Idle computing nodes satisfying the selection criteria may be flagged and/or added to a set of computing nodes for the node health assessment. The automated task scheduler, in one or more embodiments, may function to designate at least a subset of the flagged idle computing nodes satisfying the selection criteria as a batch for testing. In some embodiments, the batch may be dynamically adjustable to accommodate changes in node availability and status.

Additionally, or alternatively, in one or more embodiments, the selection algorithm, when executed, prioritizes idle computing nodes that have not undergone recent health assessments to ensure a wide coverage of the cluster of computing nodes over time. Additionally, the automated task scheduler may factor in the current workload of the cluster of computing nodes and predict future demand of the cluster of computing nodes to prevent potential shortages in computing resources within the cluster during a performance of the node health assessment.

Moreover, in one or more embodiments, the selected set or batch of idle computing nodes may be prepared for an assignment to the node health assessment queue, as described in more detail in S230. The preparation, in such embodiments, may include temporarily reserving the batch of idle computing nodes and ensuring that the batch of idle computing nodes are not assigned new tasks during the health assessment period.

### 2.30 Node Health Assessment Queue

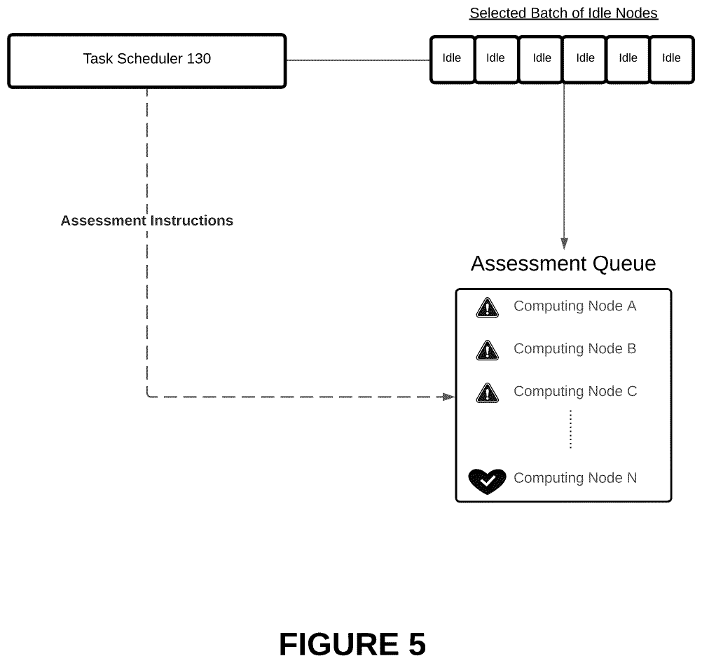

S230, which includes assigning the set of computing nodes to a node health assessment queue, may include the automated task scheduler reserving the selected idle computing nodes for health assessment activities, as shown by way of example in FIG. 5. In one or more embodiments, the assignment and/or reservation process by the automated task scheduler ensures that the designated idle computing nodes are temporarily taken out of the pool of available resources of a target cluster of computing nodes for executing various computing tasks. In such embodiments, the automated task scheduler would prohibit or bypass an assignment of one or more computing tasks or computing jobs (e.g., networking, processing, storing, and/or the like) to the designated batch of idle computing nodes.

In a preferred embodiment, assigning the batch of idle computing nodes to a node health assessment queue includes S230 updating status data associated with each of the computing nodes within the batch or selected set of idle computing nodes to indicate that they are reserved for a node health assessment. As a technical advantage, the reservation of the selected idle computing nodes may function to prevent these computing nodes from being allocated to any new or ongoing computing tasks.

Furthermore, in one or more embodiments, the automated task scheduler may function to actively manage the node health assessment queue based on historical performance data associated with computing nodes within the queue and/or health testing policy. In a non-limiting example, the automated task scheduler may prioritize testing of idle computing nodes having historical performance or health problems. In another non-limiting example, the automated task scheduler may prioritize a testing of idle computing nodes based on health testing policy indicating a periodic cadence for testing computing nodes of a target computing cluster.

Additionally, or alternatively, S230 may function to flag or mark each idle computing node in the selected set with a status indicating its unavailability for general computing tasks. The status change of each computing node may be propagated across the cluster management system to inform all relevant components and users of the computing nodes' temporary unavailability. The automated task scheduler may additionally or alternatively function to ensure that the assignment to the node health assessment queue does not conflict with any critical system operations or scheduled tasks. Accordingly, in one or more embodiments, when necessary, the automated task scheduler may reassign one or more idle computing nodes within the node health assessment queue or delay tasks to accommodate the node health assessment or other computing resource requirement.

### 2.40 Instructioning for Executing a Health Assessment

S240, which includes submitting a set of instructions for executing the node health assessment to the set of idle computing nodes within the node health assessment queue, may include causing the automated task scheduler to dispatch one or more commands or signals to initiate the health assessment process. In one or more embodiments, the one or more commands from the automated task scheduler may include assessment instructions that identify a pool of tests that will be executed by a given batch of idle computing nodes, an identification or listing of the idle computing nodes within a testing batch, a testing sequence of pairings of nodes within the batch, and/or the like. It shall be recognized that the one or more commands from the automated task scheduler may include any suitable instructions for enabling the batch of idle computing nodes to complete peer-to-peer based node health assessments. Additionally, or alternatively, the set of idle computing nodes, based on the instructions from the task scheduler may function to automatically perform one or more node health assessments as described in U.S. patent application Ser. Nos. 18/604,417 and 18/604,425, which are incorporated herein in their entireties.

In one or more embodiments, submitting the set of instructions may include causing the automated task scheduler to prepare a set of testing instructions that define the parameters and procedures for the node health assessment. In one or more embodiments, the testing instructions may include specific tests to be performed, data to be collected, and any operational limits or thresholds for the given batch of idle computing nodes. Once the testing instructions are prepared, in one or more embodiments, S240 may include transmitting, by the automated task scheduler, the testing instructions to each computing node or an administrative node within the given batch of idle computing nodes within the node health assessment queue. The dispatch of the testing instructions may be accomplished via direct or indirect communication channels established between the automated task scheduler and the given batch of idle computing nodes.

Additionally, or alternatively, in response to receiving the testing instructions, each computing node within the given batch of idle computing nodes may automatically execute the node health assessment. In one or more embodiments, the automatic execution of the node health assessment may include executing the one or more specified tests of the testing instructions and storing or transmitting various performance metrics and operational parameters. In such embodiments, during the execution of the node health assessment, the automated task scheduler may continuously monitor the progress and status of the assessments and may function to make real-time adjustments to the testing instructions, if necessary, based on interim results or detected anomalies.

Additionally, or alternatively, in one or more embodiments, the set of testing instructions from the automated task scheduler may include detailed guidelines for performing the health assessments, such as: specific tests to evaluate CPU, GPU, memory, and network performances. Additionally, the testing instructions may include requirements for logging performance metrics, error rates, and other relevant data and protocols for reporting testing results to the automated task scheduler.

Additionally, or alternatively, the testing instructions may be customized based on the type and configuration of the computing nodes being assessed. In such embodiments, the automated task scheduler may function to ensure that each computing node receives the appropriate set of testing instructions tailored to its specific hardware and operational characteristics of the respective computing node.

### 2.50 Health Assessment Data & Metrics|Unhealthy Node Detection

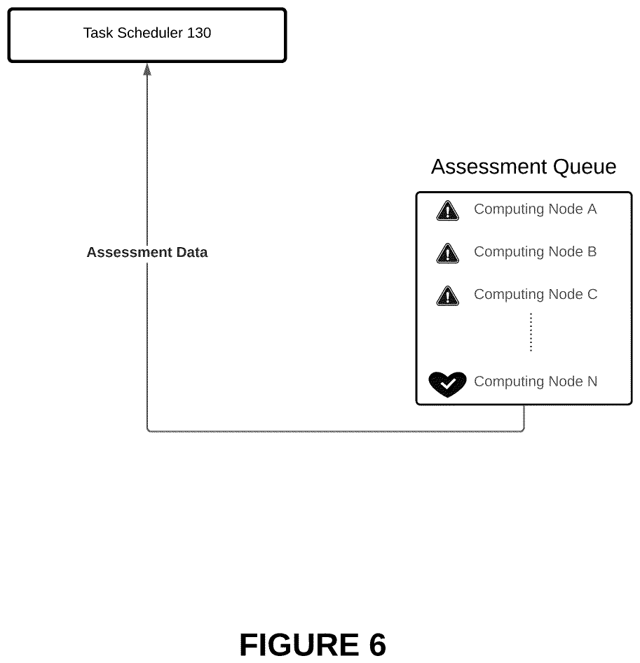

S250, which includes obtaining results of the node health assessment and identifying a state of health of each computing node of the set of idle computing nodes, may include collecting and analyzing the assessment data generated during the node health assessment process, as shown by way of example in FIG. 6. In a preferred embodiment, based on an evaluation of the assessment data, S250 may function to identify, via the automated task scheduler or the like, a state of health of each of the computing nodes of the set of idle computing nodes.

In one or more embodiments, a collection of the assessment data may include generating by each computing node in the node health assessment queue performance and diagnostic data during the execution of the node health assessment. In a first implementation, the performance and diagnostic data (i.e., assessment data) produced by the computing nodes may be transmitted midstream of and/or as the node health assessment is being executed by the batch or set of idle computing nodes. That is, the automated task scheduler may function to obtain or collect assessment data in real-time or near real-time during the execution of the node health assessment. In this way, the automated task scheduler may function to determine remediating actions or operations to perform against any unhealthy computing node within the batch as the node health assessment is being completed thereby accelerating a mitigation of a likely degradative effect of any unhealthy nodes. In a second implementation, the performance and diagnostic data produced by the computing nodes may be tentatively stored by each respective computing node or an administrative computing node within the node health assessment. In this second implementation, once the node health assessment is completed or otherwise stopped for any reason, S250 may function to collect a coalesced data packet that includes the assessment data of the node health assessment. In this way, a single or minimal number of data packets may be transmitted to the automated task scheduler thereby reducing interruptions of one or more primary or main job functions of the automated task scheduler including, but not limited to, assigning jobs to the cluster of computing nodes.

Additionally, or alternatively, the transmission of the assessment data may occur over a dedicated communication channel to ensure data integrity. In response to receiving the assessment data, the automated task scheduler may perform an initial validation of the assessment data to ensure completeness and accuracy. This validation process, in some embodiments, may include checks for data consistency, error detection, and verification against predefined thresholds or criteria. The validated data from all assessed nodes may be compiled into a comprehensive report identifying a state of health of each of the computing nodes of the node health assessment together with health assessment metrics and related assessment data. Accordingly, the health assessment report generated by the automated task scheduler may identify anomalous attributes or behaviors of the computing nodes or other issues detected as a result of the node health assessment.

### 2.6 Reallocating the Computing Nodes

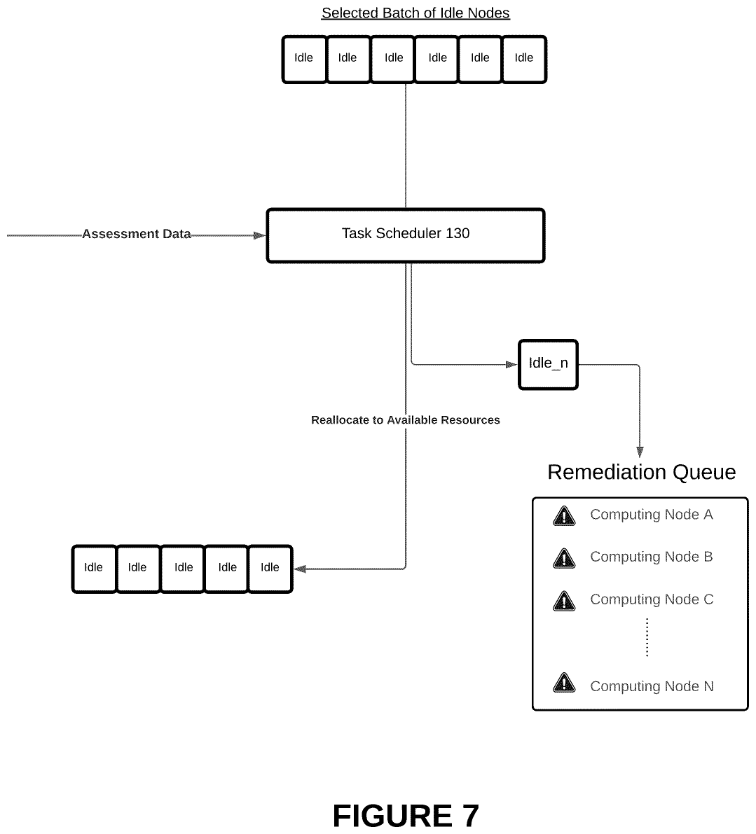

S260, which includes reallocating the set of idle computing nodes based on a completion of the node health assessment, may include reassigning or removing from the node health assessment queue the one or more computing nodes of the set of computing nodes based on health state data (e.g., health state or unhealthy state) or based on the assessment results, as shown by way of example in FIG. 7. Additionally, or alternatively, reallocating the set of idle computing nodes after the node health assessment may include re-assigning or re-allocating one or more of the set of idle computing nodes to a node remediation queue or node remediation process if one or more of the set of idle computing nodes are determined to have an unhealthy state.

Accordingly, in one or more embodiments, reallocating the set of idle computing nodes may include updating status data, i.e., changing the operational status, of each of the set of idle computing node to one of healthy or unhealthy based on the determination by the automated task scheduler, as described in S250 and the like. In a non-limiting example, for each computing node identified as healthy, the automated task scheduler may function to update the computing node's status from “under assessment” to “available”. Conversely, in another non-limiting example, for each computing node identified as unhealthy, the automated task scheduler may function to update the computing node's status from “under assessment” to “under remediation-unavailable” or the like. In such embodiments, the status data assigned to each computing node of the set of idle computing nodes may inform a routing of the computing node back to the pool of available computing resources or to a remediation queue.

Additionally, or alternatively, the status change of a given computing node may be propagated throughout the cluster management system managing a target cluster of computing nodes. That is, the automated task scheduler may function to communicate the status data of each computing node in the set of idle computing nodes to relevant components of the cluster management system and/or users, ensuring that this change is communicated to all relevant components and users, ensuring that the computing nodes are recognized as available for task allocation or unavailable and in need of maintenance or repair.

### 3. Computer-Program Product

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A method for automated scheduler-controlled computing node testing in a computing cluster, the method comprising:
detecting, by a computing task scheduler, a plurality of idle nodes of a cluster of computing nodes, wherein the plurality of idle nodes includes computing nodes of the cluster of computing nodes that are in an idle state;
selecting, by the computing task scheduler, a set of computing nodes of the plurality of idle nodes for a node health assessment;
assigning the set of computing nodes to a node health assessment queue, wherein when the assignment of the set of computing nodes to the node health assessment queues renders the set of computing nodes unavailable for executing one or more computing tasks assigned by the computing task scheduler to the cluster of computing nodes;
submitting, by the computing task scheduler, to the set of computing nodes within the node health assessment queue a set of instructions for executing the node health assessment;
obtaining, by the computing task scheduler, assessment results based on the execution of the node health assessment by the set of computing nodes;
determining a state of health data for each computing node of the set of computing nodes based on the assessment results; and
reallocating, by the computing task scheduler, the set of computing nodes from the node health assessment queue based on the state of health data for each computing node of the set of computing nodes.

2. The method according to claim 1, wherein:
determining the state of health data includes identifying one or more computing nodes of the set of computing nodes as having a healthy state, wherein the healthy state relates to a likely operational status of a subject computing node satisfying the node health assessment.

3. The method according to claim 2, wherein:
reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the computing task scheduler to the cluster of computing nodes.

4. The method according to claim 2, wherein the one or more computing nodes of the set of computing nodes having the healthy state are restricted from executing another instance of the node health assessment for a predetermined period.

5. The method according to claim 1, wherein:
determining the state of health data includes identifying one or more computing nodes of the set of computing nodes as having an unhealthy state, wherein the unhealthy state relates to a likely operational status of a subject computing node that does not satisfy the node health assessment.

6. The method according to claim 5, wherein:
reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the computing task scheduler to the cluster of computing nodes.

7. The method according to claim 1, wherein the execution of the node health assessment by the set of computing nodes includes:
executing bi-directional testing between distinct pairs of computing nodes of the set of computing nodes by executing one or more operational health tests of the node health assessment.

8. The method according to claim 1, wherein:
selecting, by the computing task scheduler, the set of computing nodes of the plurality of idle nodes includes bypassing one or more computing nodes of the plurality of idle nodes that do not satisfy idleness criteria, and
the idleness criteria requiring a given idle computing node to be (1) in an idle operational state and (2) without computing tasks scheduled for an impending period.

9. The method according to claim 1, further comprising:
configuring the computing task scheduler with one or more node health assessment criteria including non-interference automated node testing instructions,
wherein the non-interference automated node testing instructions, when executed by the computing task scheduler, prioritizes for the node health assessment computing nodes of the plurality of idle nodes without a scheduled computing task while bypassing computing nodes of the plurality of idle nodes with scheduled computing tasks.

10. A computer-program product comprising a non-transitory machine-readable storage medium storing computer instructions that, when executed by one or more processors, perform operations comprising:
detecting, by a computing task scheduler, a plurality of idle nodes of a cluster of computing nodes, wherein the plurality of idle nodes includes computing nodes of the cluster of computing nodes that are in an idle state;
selecting, by the computing task scheduler, a set of computing nodes of the plurality of idle nodes for a node health assessment;
assigning the set of computing nodes to a node health assessment queue, wherein when the assignment of the set of computing nodes to the node health assessment queues renders the set of computing nodes unavailable for executing one or more computing tasks assigned by the computing task scheduler to the cluster of computing nodes;
submitting, by the computing task scheduler, to the set of computing nodes within the node health assessment queue a set of instructions for executing the node health assessment;
obtaining, by the computing task scheduler, assessment results based on the execution of the node health assessment by the set of computing nodes;
determining a state of health data for each computing node of the set of computing nodes based on the assessment results; and
reallocating, by the computing task scheduler, the set of computing nodes from the node health assessment queue based on the state of health data for each computing node of the set of computing nodes.

11. The computer-program product according to claim 10, wherein:
determining the state of health data includes identifying one or more computing nodes of the set of computing nodes as having a healthy state, wherein the healthy state relates to a likely operational status of a subject computing node satisfying the node health assessment.

12. The computer-program product according to claim 11, wherein:
reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the computing task scheduler to the cluster of computing nodes.

13. The computer-program product according to claim 11, wherein the one or more computing nodes of the set of computing nodes having the healthy state are restricted from executing another instance of the node health assessment for a predetermined period.

14. The computer-program product according to claim 10, wherein:
determining the state of health data includes identifying one or more computing nodes of the set of computing nodes as having an unhealthy state, wherein the unhealthy state relates to a likely operational status of a subject computing node that does not satisfy the node health assessment.

15. The computer-program product according to claim 14, wherein:
reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the computing task scheduler to the cluster of computing nodes.

16. The computer-program product according to claim 10, wherein the execution of the node health assessment by the set of computing nodes includes:
executing bi-directional testing between distinct pairs of computing nodes of the set of computing nodes by executing one or more operational health tests of the node health assessment.

17. The computer-program product according to claim 10, wherein:
selecting, by the computing task scheduler, the set of computing nodes of the plurality of idle nodes includes bypassing one or more computing nodes of the plurality of idle nodes that do not satisfy idleness criteria, and
the idleness criteria requiring a given idle computing node to be (1) in an idle operational state and (2) without computing tasks scheduled for an impending period.

18. A computer-implemented method comprising:
detecting, by a task scheduler, a plurality of idle nodes of a cluster of computing nodes, wherein the plurality of idle nodes includes computing nodes of the cluster of computing nodes that are in an idle state;
selecting, by the task scheduler, a set of computing nodes of the plurality of idle nodes for a node health assessment;
assigning the set of computing nodes to a node health assessment queue, wherein when the assignment of the set of computing nodes to the node health assessment queues renders the set of computing nodes unavailable for executing one or more computing tasks assigned by the task scheduler to the cluster of computing nodes;
submitting, by the task scheduler, to the set of computing nodes within the node health assessment queue a set of instructions for executing the node health assessment;
obtaining, by the task scheduler, assessment results based on the execution of the node health assessment by the set of computing nodes;
determining a state of health data for each computing node of the set of computing nodes based on the assessment results; and
reallocating, by the task scheduler, the set of computing nodes from the node health assessment queue based on the state of health data for each computing node of the set of computing nodes.

19. The computer-program product according to claim 18, wherein:
determining the state of health data includes identifying one or more computing nodes of the set of computing nodes as having a healthy state, wherein the healthy state relates to a likely operational status of a subject computing node satisfying the node health assessment; and
reallocating the set of computing nodes includes reassigning the one or more computing nodes having the healthy state from the node health assessment queue to available computing resources of the cluster of computing resources, wherein the reassignment of the one or more computing nodes having the healthy state to the available computing resources renders the one or more computing nodes available for executing the one or more computing tasks assigned by the task scheduler to the cluster of computing nodes.

20. The computer-program product according to claim 18, wherein the one or more computing nodes of the set of computing nodes having the healthy state are restricted from executing another instance of the node health assessment for a predetermined period; and
reallocating the set of computing nodes includes reassigning the one or more computing nodes having the unhealthy state from the node health assessment queue to a remediation queue, wherein the reassignment of the one or more computing nodes having the healthy state to the remediation queue renders the one or more computing nodes unavailable for executing the one or more computing tasks assigned by the task scheduler to the cluster of computing nodes.
